(19) United States
(12) Patent Application Publication
(10) Pub. No.: US 2011/0113118 A1
(43) Pub. Date: May 12, 2011

(54) Contents Providing System, Terminal Apparatus, And Contents Controlling Apparatus

(75) Inventors: Hideki Matsuda, Nagano-ken (JP); Hidetsugu Obi, Nagano-ken (JP); John Slater Reaves, New York, NY (US); Christine L. Prentice, Brooklyn, NY (US)

(73) Assignee: SEIKO EPSON CORPORATION, Tokyo (JP)

(21) Appl. No.: 12/854,244

(22) Filed: Aug. 11, 2010

Related U.S. Application Data
(60) Provisional application No. 61/258,936, filed on Nov. 6, 2009.

(51) Int. Cl. G06F 15/16

(52) U.S. Cl. 709/217

(57) ABSTRACT

A contents providing system provides a content and attached information of the content stored in a contents controlling apparatus to a terminal apparatus. The contents providing system includes a determination section that determines whether or not a specific content among a plurality of contents stored in the contents controlling apparatus is stored in the terminal apparatus, and a transfer section that transfers the specific content and attached information of the specific content to the terminal apparatus when the determination section determines that the specific content is not stored in the terminal apparatus, and transfers only the attached information of the specific content instead of both the specific content and the attached information of the specific content when the determination section determines that the specific content is stored in the terminal apparatus.

### CROSS-REFERENCE TO RELATED APPLICATIONS

This application claims the benefit of U.S. Provisional Application Ser. No. 61/258,936, filed on Nov. 6, 2009, the contents of which are incorporated herein by reference.

### BACKGROUND

1. Technical Field

The present invention relates to a contents providing system, a terminal apparatus, a contents controlling apparatus, a contents providing method, a program, and computer readable record media.

2. Related Art

A technique for remotely accessing a recorded content recorded in a transponder, creating annotation data of the recorded content without changing the recorded content, and storing the created annotation data in the transponder has been disclosed (for example, refer to JP-A-2004-118836).

However, the above described technique cannot perform data communication without applying a heavy load to a communication network.

### SUMMARY

An advantage of some aspects of the invention is to provide a contents providing system, a terminal apparatus, a contents providing method, and a program, which can perform data communication without applying a heavy load to a communication network.

According to a first aspect of the invention, a contents providing system which provides a content and attached information of the content stored in a contents controlling apparatus to a terminal apparatus includes a determination section for determining whether or not a specific content among a plurality of contents stored in the contents controlling apparatus is stored in the terminal apparatus, and a transfer section for transferring the specific content and attached information of the specific content to the terminal apparatus when the determination section determines that the specific content is not stored in the terminal apparatus, and transferring only the attached information of the specific content instead of both the specific content and the attached information of the specific content when the determination section determines that the specific content is stored in the terminal apparatus. According to the contents providing system of the invention, when the determination section determines that the specific content is not stored in the terminal apparatus, the specific content and the attached information of the specific content are transferred to the terminal apparatus, and when the determination section determines that the specific content is stored in the terminal apparatus, although the attached information of the specific content is transferred to the terminal apparatus, the specific content is not transferred to the terminal apparatus, so that a load applied to the communication network can be reduced.

It is preferable that the contents providing system further includes a first attached information updating section for creating updated attached information by updating the attached information stored in the terminal apparatus, an attached information transmission section for transmitting the updated attached information to the contents controlling apparatus, and a second attached information updating section for updating the attached information stored in the contents controlling apparatus by using the updated attached information. According to the above configuration, while reducing the load applied to the communication network, it is possible to update the attached information stored in the contents controlling apparatus to the updated attached information by the first attached information updating section.

According to a second aspect of the invention, a terminal apparatus which stores a specific content among a plurality of contents stored in a contents controlling apparatus and attached information of the specific content includes a determination section for determining whether or not the specific content is stored in the terminal apparatus, and a transfer section for controlling the contents controlling apparatus so that the contents controlling apparatus transfers the specific content and the attached information of the specific content to the terminal apparatus when the determination section determines that the specific content is not stored in the terminal apparatus, and controlling the contents controlling apparatus so that the contents controlling apparatus transfers only the attached information of the specific content instead of both the specific content and the attached information of the specific content when the determination section determines that the specific content is stored in the terminal apparatus. According to the terminal apparatus of the invention, when the determination section determines that the specific content is not stored in the terminal apparatus, the specific content and the attached information of the specific content are transferred to the terminal apparatus, and when the determination section determines that the specific content is stored in the terminal apparatus, although the attached information of the specific content is transferred to the terminal apparatus, the specific content is not transferred to the terminal apparatus, so that a load applied to the communication network can be reduced.

It is preferable that the terminal apparatus further includes a first attached information updating section for creating updated attached information by updating the attached information transferred from the contents controlling apparatus, and an attached information transmission section for transmitting the updated attached information to the contents controlling apparatus. According to the above configuration, while reducing the load applied to the communication network, it is possible to update the attached information stored in the contents controlling apparatus to the updated attached information by the first attached information updating section.

According to a third aspect of the invention, a contents controlling apparatus which provides a specific content among a plurality of contents and attached information of the specific content includes a determination section for determining whether or not the specific content is stored in the terminal apparatus, and a transfer section for transferring the specific content and the attached information of the specific content to the terminal apparatus when the determination section determines that the specific content is not stored in the terminal apparatus, and transferring only the attached information of the specific content instead of both the specific content and the attached information of the specific content when the determination section determines that the specific content is stored in the terminal apparatus. According to the contents controlling apparatus of the invention, when the specific content is determined not to be stored in the terminal apparatus, the specific content and the attached information of the specific content are transferred to the terminal apparatus, and when the specific content is determined to be stored in the terminal apparatus, although the attached information of the specific content is transferred to the terminal apparatus, the specific content is not transferred to the terminal apparatus, so that a load applied to the communication network can be reduced.

It is preferable that the contents controlling apparatus further includes an attached information updating section for updating the attached information stored in the contents controlling apparatus by using attached information transferred from the terminal apparatus. According to the above configuration, while reducing the load applied to the communication network, it is possible to update the attached information stored in the contents controlling apparatus to the attached information transferred from the terminal apparatus.

According to a fourth aspect of the invention, a contents providing method which provides a content and attached information of the content includes a determining step of determining whether or not a specific content among a plurality of contents stored in a first information processing apparatus is stored in a second information processing apparatus, and a transferring step of transferring the specific content and the attached information of the specific content to the second information processing apparatus when the specific content is determined not to be stored in the second information processing apparatus in the determining step, and transferring only the attached information of the specific content instead of both the specific content and the attached information of the specific content when the specific content is determined to be stored in the second information processing apparatus in the determining step. According to the contents providing method of the invention, when the specific content is determined not to be stored in the second information processing apparatus, the specific content and the attached information of the specific content are transferred to the second information processing apparatus, and when the specific content is determined to be stored in the second information processing apparatus, although the attached information of the specific content is transferred to the second information processing apparatus, the specific content is not transferred to the second information processing apparatus, so that a load applied to the communication network can be reduced.

According to a fifth aspect of the invention, a program causes a computer to perform functions including a function as a determination section for determining whether or not a specific content among a plurality of contents stored in the contents controlling apparatus is stored in the terminal apparatus, and a function as a transfer control section for controlling the contents controlling apparatus so that the contents controlling apparatus transfers the specific content and attached information of the specific content to the terminal apparatus when the determination section determines that the specific content is not stored in the terminal apparatus, and controlling the contents controlling apparatus so that the contents controlling apparatus transfers only the attached information of the specific content instead of both the specific content and the attached information of the specific content when the determination section determines that the specific content is stored in the terminal apparatus. According to the program of the invention, by executing the program by a computer, when the determination section determines that the specific content is not stored in the terminal apparatus, the specific content and the attached information of the specific content are transferred to the terminal apparatus, and when the determination section determines that the specific content is stored in the terminal apparatus, although the attached information of the specific content is transferred to the terminal apparatus, the specific content is not transferred to the terminal apparatus, so that a load applied to the communication network can be reduced.

According to a sixth aspect of the invention, a computer-readable record medium records the above described program. According to the computer readable record medium of the invention, by causing a computer to execute the program recorded in the record medium, when the determination section determines that the specific content is not stored in the terminal apparatus, the specific content and the attached information of the specific content are transferred to the terminal apparatus, and when the determination section determines that the specific content is stored in the terminal apparatus, although the attached information of the specific content is transferred to the terminal apparatus, the specific content is not transferred to the terminal apparatus, so that a load applied to the communication network can be reduced.

### BRIEF DESCRIPTION OF THE DRAWINGS

The invention will be described with reference to the accompanying drawings, wherein like numbers reference like elements.

FIG. 1 shows an example of a contents providing system 10 according to an embodiment.

FIG. 2 shows an example of a functional configuration of the contents providing system 10.

FIG. 3 shows an example of a processing procedure of the contents providing system 10.

FIG. 4 shows another example of a processing procedure of the contents providing system 10.

FIG. 5 shows an example of information stored in the contents providing system 10.

FIG. 6 shows an example of a hardware configuration of a terminal apparatus 100.

FIG. 7 shows an example of a functional configuration of a contents providing system 20 according to an embodiment 2.

FIG. 8 shows an example of a processing procedure of the contents providing system 20.

### DESCRIPTION OF EXEMPLARY EMBODIMENTS

### Embodiment 1

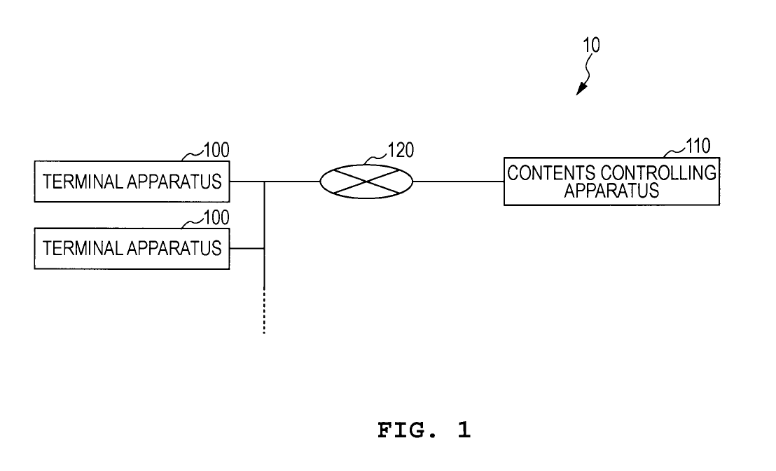

FIG. 1 shows an example of a contents providing system 10 according to an embodiment. The contents providing system 10 provides a content and attached information of the content to a terminal apparatus 100. The contents providing system 10 includes a terminal apparatus 100 (second information processing apparatus) and a contents controlling apparatus 110 (first information processing apparatus). The terminal apparatus 100 and the contents controlling apparatus 110 are respectively connected to a communication network 120 such as the Internet, LAN, Wi-Fi, a fixed-line phone network, and a mobile phone network, and a content and attached information are transferred between the terminal apparatus 100 and the contents controlling apparatus 110. The terminal apparatus 100 and the contents controlling apparatus 110 may be connected to each other via wired communication or wireless communication without using the communication network 120.

Here, a content means document data, photograph data, music data, video data, or a combination thereof. For example, an example of a content is PDF (Portable Document Format) data. The attached information is information associated with the content, and indicates information related to the content. For example, when the content is PDF data, an example of the attached information is annotation data written by a user regarding the PDF data. The attached information is recorded in a file different from the content. The contents providing system 10 can transfer the attached information separately from the content between the terminal apparatus 100 and the contents controlling apparatus 110. The attached information may be recorded in the same file as the content. The attached information may be constituted by a plurality of files.

The contents controlling apparatus 110 stores a plurality of contents and a plurality of attached information items in a database. The contents controlling apparatus 110 integrally manages the plurality of contents and the plurality of attached information items stored in the database. For example, the contents controlling apparatus 110 extracts a content and attached information from the database and transmits the extracted content and attached information to the terminal apparatus 100 responding to a request from the terminal apparatus. The contents controlling apparatus 110 can obtain a content or attached information transmitted from the terminal apparatus 100, and store the obtained content or attached information in the database. The database may be included in the contents controlling apparatus 110, or may be included in an external information processing apparatus connected to the contents controlling apparatus 110.

The terminal apparatus 100 is an information processing apparatus such as a PDA (Personal Digital Assistant), a mobile phone, or a personal computer, which handles contents. For example, the terminal apparatus 100 obtains a content and attached information from the contents controlling apparatus 110, and stores the obtained content and attached information. The terminal apparatus 100 can reproduce, display, and edit the content and attached information obtained from the contents controlling apparatus 110. An example of the terminal apparatus 100 is an electronic book which handles PDF data as a content.

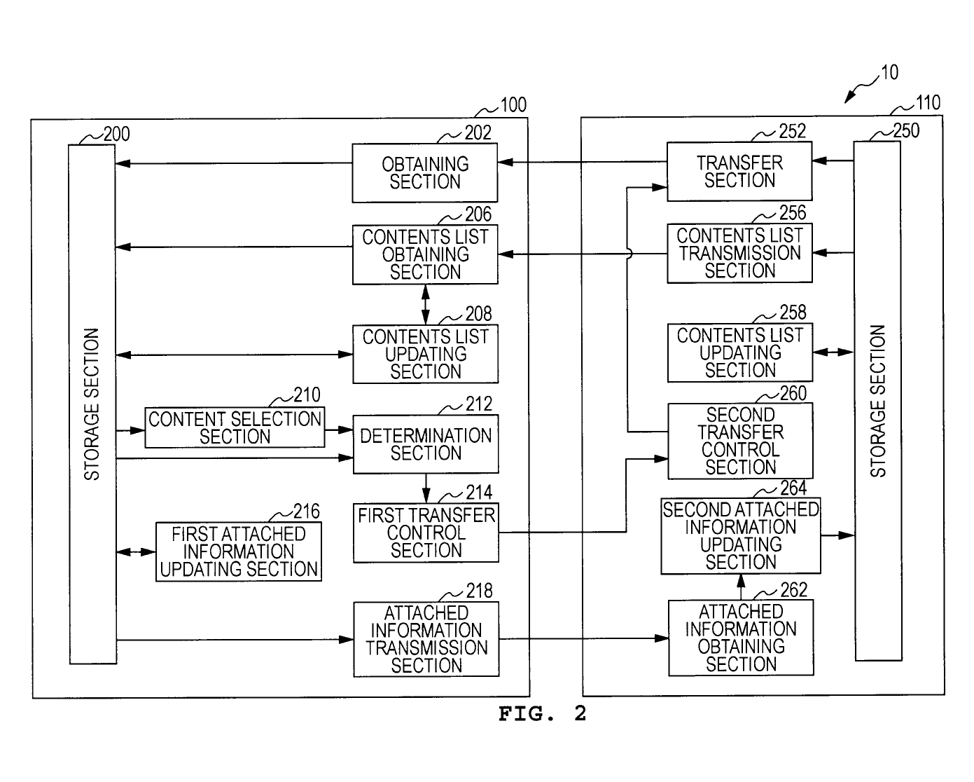

FIG. 2 shows an example of a functional configuration of the contents providing system 10. The terminal apparatus 100 includes a storage section 200, an obtaining section 202, a contents list obtaining section 206, a contents list updating section 208, a content selection section 210, a determination section 212, and a first transfer control section 214.

The storage section 200 stores a plurality of contents. The storage section 200 stores the attached information of the contents by associating one of the attached information items with one of the plurality of contents. The storage section 200 stores a contents list (hereinafter, referred to as “contents list of the terminal apparatus 100”) showing a plurality of contents stored in the storage section 200. Also, the storage section 200 stores a contents list (hereinafter, referred to as “contents list of the contents controlling apparatus 110”) showing a plurality of contents stored in a storage section 250 of the contents controlling apparatus 110.

The obtaining section 202 obtains a content. For example, the obtaining section 202 obtains a content transmitted from the contents controlling apparatus 110. The obtaining section 202 stores the obtained content in the storage section 200. Also, the obtaining section 202 obtains attached information. For example, the obtaining section 202 obtains attached information transmitted from the contents controlling apparatus 110. The obtaining section 202 stores the obtained attached information in the storage section 200.

The contents list obtaining section 206 obtains a contents list. For example, the contents list obtaining section 206 obtains a contents list of the contents controlling apparatus 110 transmitted from the contents controlling apparatus 110. The contents list obtaining section 206 stores the obtained contents list of the contents controlling apparatus 110 in the storage section 200.

The contents list updating section 208 refers to the storage section 200 and creates the contents list of the terminal apparatus 100. The contents list updating section 208 stores the created contents list of the terminal apparatus 100 in the storage section 200. The contents list updating section 208 refers to the storage section 200 at regular intervals or at an arbitrary timing, and updates the contents list of the terminal apparatus 100 stored in the storage section 200 to the latest state. Also, the contents list updating section 208 causes the contents list obtaining section 206 to obtain the latest contents list of the contents controlling apparatus 110 at regular intervals or at an arbitrary timing, and updates the contents list of the contents controlling apparatus 110 stored in the storage section 200 to the latest state.

The content selection section 210 selects a content from a plurality of contents stored in the contents controlling apparatus 110. For example, the content selection section 210 displays the contents list of the contents controlling apparatus 110 stored in the storage section 200 on a display device, receives a selection operation for any one of the contents by an input device, and thereby selects a content from a plurality of contents stored in the contents controlling apparatus 110.

The determination section 212 determines whether or not the content selected by the content selection section 210 is stored in the terminal apparatus 100. For example, the determination section 212 determines whether or not the content selected by the content selection section 210 is stored in the terminal apparatus 100 in accordance with whether or not the content is included in the contents list of the terminal apparatus 100. In addition, the determination section 212 may determine whether or not the content is stored in the terminal apparatus 100 by obtaining a file list of the storage section 200 and a file list of the storage section 250 and referring to the obtained file lists without referring to the contents list.

The first transfer control section 214 controls transfer of a content from the contents controlling apparatus 110 to the terminal apparatus 100. Specifically, when the determination section 212 determines that the content selected by the content selection section 210 is not stored in the terminal apparatus 100, the first transfer control section 214 causes the contents controlling apparatus 110 to transmit the content and attached information of the content to the terminal apparatus 100.

For example, the first transfer control section 214 transmits request information which indicates identification information of the content and requests the content and the attached information of the content, to the contents controlling apparatus 110, and thereby causes the contents controlling apparatus 110 to transmit the content and the attached information of the content to the terminal apparatus 100. In this way, the content and the attached information of the content are transferred from the contents controlling apparatus 110 to the terminal apparatus 100.

On the other hand, when the determination section 212 determines that the content selected by the content selection section 210 is stored in the terminal apparatus 100, although the first transfer control section 214 causes the contents controlling apparatus 110 to transmit the attached information of the content to the terminal apparatus 100, the first transfer control section 214 does not cause the contents controlling apparatus 110 to transmit the content.

For example, the first transfer control section 214 transmits request information which indicates identification information of the attached information of the content selected by the content selection section 210 and requests the attached information of the content, to the contents controlling apparatus 110, and thereby causes the contents controlling apparatus 110 to transmit the attached information of the content to the terminal apparatus 100. In this way, only the attached information instead of both the content and the attached information of the content is transferred from the contents controlling apparatus 110 to the terminal apparatus 100.

The terminal apparatus 100 according to the embodiment includes a first attached information updating section 216 and an attached information transmission section 218. The first attached information updating section 216 creates updated attached information by updating the attached information stored in the storage section 200. For example, the first attached information updating section 216 displays the contents list of the contents controlling apparatus 110 stored in the storage section 200 on the display device, and receives a selection operation for any one of the contents performed by the input device. Then, the first attached information updating section 216 extracts the attached information of the selected content from the storage section 200, and displays the extracted attached information on the display device. Further, the first attached information updating section 216 receives an editing operation of the attached information by the input device. Thereby, the first attached information updating section 216 updates the attached information.

The attached information transmission section 218 transmits the attached information to the contents controlling apparatus 110. For example, the attached information transmission section 218 transmits the attached information updated by the first attached information updating section 216 from a plurality of attached information items stored in the storage section 200. However, the attached information transmission section 218 does not transmit the content corresponding to the attached information to the contents controlling apparatus 110. The attached information transmission section 218 may transmit the updated attached information every time the first attached information updating section 216 updates the attached information, or the attached information transmission section 218 may collectively transmit the updated attached information items at regular intervals or at an arbitrary timing.

The contents controlling apparatus 110 includes a storage section 250, a transfer section 252, a contents list transmission section 256, a contents list updating section 258, a second transfer control section 260, an attached information obtaining section 262, and a second attached information updating section 264.

The storage section 250 stores a plurality of contents. The storage section 250 stores the attached information of the content by associating one of the attached information items with one of the plurality of contents respectively. The storage section 250 stores the contents list of the contents controlling apparatus 110.

The transfer section 252 transfers the content to the terminal apparatus 100. For example, the transfer section 252 extracts the content from the storage section 250, and transfers the extracted content to the terminal apparatus 100. The transfer section 252 transfers the attached information to the terminal apparatus 100. For example, the transfer section 252 extracts the attached information from the storage section 250, and transfers the extracted attached information to the terminal apparatus 100.

The contents list transmission section 256 transmits the contents list of the contents controlling apparatus 110. For example, the contents list transmission section 256 extracts the contents list of the contents controlling apparatus 110 from the storage section 250, and transmits the extracted contents list of the contents controlling apparatus 110 to the terminal apparatus 100.

The second transfer control section 260 controls transfer of the content and the attached information from the contents controlling apparatus 110 to the terminal apparatus 100. For example, when the second transfer control section 260 receives content request information from the terminal apparatus 100, the second transfer control section 260 issues an instruction for transferring the content specified by a content ID indicated by the received request information to the terminal apparatus 100 to the transfer section 252. Upon receiving the instruction, the transfer section 252 transfers the content to the terminal apparatus 100. When the second transfer control section 260 receives request information of the attached information of the content, the second transfer control section 260 issues an instruction for transferring the attached information of the content specified by the content ID indicated by the received request information to the terminal apparatus 100 to the transfer section 252. Upon receiving the instruction, the transfer section 252 transfers the attached information of the content to the terminal apparatus 100. In this way, the content or the attached information is transferred from the contents controlling apparatus 110 to the terminal apparatus 100.

The attached information obtaining section 262 obtains the attached information. For example, the attached information obtaining section 262 obtains the attached information transmitted from the terminal apparatus 100. The attached information obtaining section 262 stores the obtained attached information in the storage section 250.

The second attached information updating section 264 updates the attached information stored in the storage section 250. For example, the second attached information updating section 264 updates the attached information stored in the storage section 250 by using the attached information obtained by the attached information obtaining section 262.

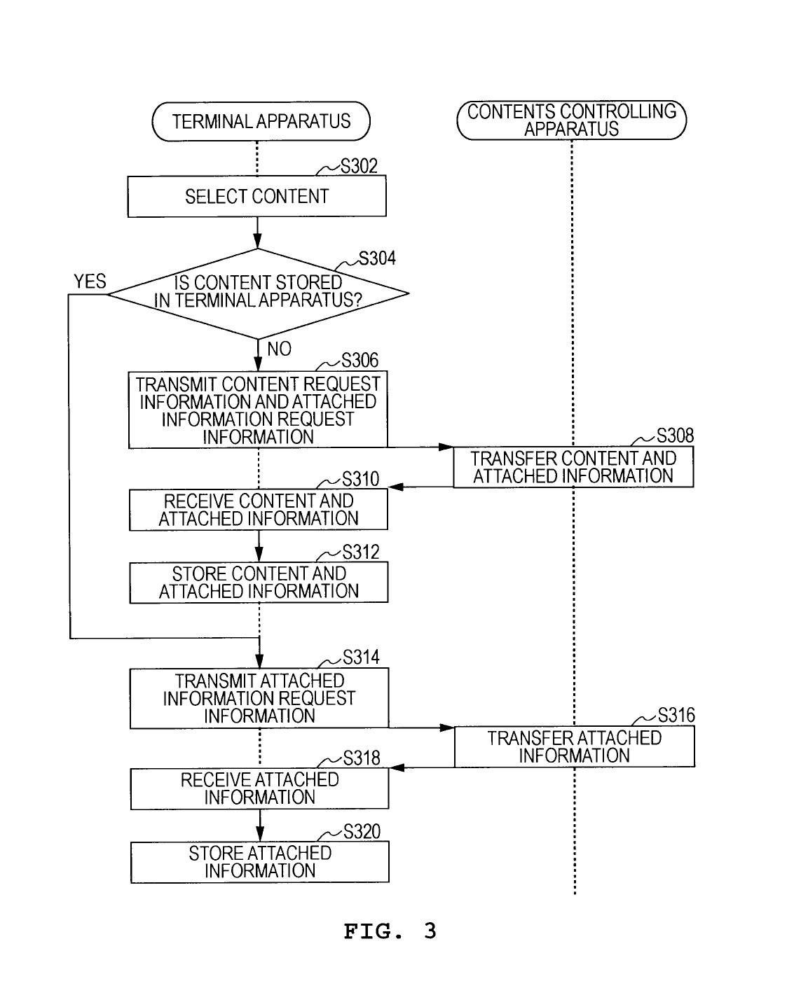

FIG. 3 shows an example of a processing procedure of the contents providing system 10. FIG. 3 shows an example of a processing procedure of the contents providing system 10 when a user of the terminal apparatus 100 selects a content which the user wants to use.

First, the content selection section 210 of the terminal apparatus 100 selects a content from a plurality of contents stored in the contents controlling apparatus 110 (step S302). Next, the determination section 212 of the terminal apparatus 100 determines whether or not the content selected in step S302 is stored in the terminal apparatus 100 (step S304).

In step S304, when the content selected in step S302 is determined not to be stored in the terminal apparatus 100 (step S304: No), the first transfer control section 214 of the terminal apparatus 100 transmits request information of the content selected in step S302 and request information of the attached information of the content selected in step S302 to the contents controlling apparatus 110 (step S306).

Under control by the second transfer control section 260 of the contents controlling apparatus 110, the transfer section 252 of the contents controlling apparatus 110 transfers the content specified by the content ID indicated by the request information received from the terminal apparatus 100 and the attached information of the content to the terminal apparatus 100 (step S308).

Further, the obtaining section 202 of the terminal apparatus 100 obtains the content and attached information transferred in step S308 (step S310). Furthermore, the obtaining section 202 of the terminal apparatus 100 stores the content and attached information obtained in step S310 in the storage section 200 (step S312).

On the other hand, in step S304, when the content selected in step S302 is determined to be stored in the terminal apparatus 100 (step S304: Yes), the first transfer control section 214 of the terminal apparatus 100 transmits request information of the attached information of the content selected in step S302 to the contents controlling apparatus 110 (step S314).

Under control by the second transfer control section 260 of the contents controlling apparatus 110, the transfer section 252 of the contents controlling apparatus 110 transfers the attached information of the content specified by the content ID indicated by the request information received from the terminal apparatus 100 to the terminal apparatus 100 (step S316).

Further, the obtaining section 202 of the terminal apparatus 100 obtains the attached information transferred in step S316 (step S318). Furthermore, the obtaining section 202 of the terminal apparatus 100 stores the attached information obtained in step S310 in the storage section 200 (step S320).

The contents providing system 10 may perform processing shown in FIG. 3 when some of or all of parameters such as a file name, a file type, a storage directory, a creation date, and so on correspond to a predetermined condition, and may not perform the processing shown in FIG. 3 when some of or all of the parameters do not correspond to the predetermined condition. The contents providing system 10 may perform the processing shown in FIG. 3 at regular intervals.

The contents providing system 10 may perform the processing shown in FIG. 3 at a timing at which a predetermined event occurs. For example, the contents providing system 10 may perform the processing shown in FIG. 3 at a timing at which a content or attached information is added, changed, or deleted in the contents providing system 10. In this case, the contents providing system 10 may perform processing shown in FIG. 3 at a timing at which a content or attached information of which some of or all of parameters such as a file name, a file type, a storage directory, a creation date, and so on correspond to a predetermined condition is added, changed, or deleted, and may not perform the processing shown in FIG. 3 at a timing at which a content or attached information of which some of or all of parameters does not correspond to the predetermined condition is added, changed, or deleted. The contents providing system 10 may perform the processing shown in FIG. 3 at a timing at which the terminal apparatus 100 is connected to the communication network 120, or at a timing at which the contents controlling apparatus 110 detects the terminal apparatus 100.

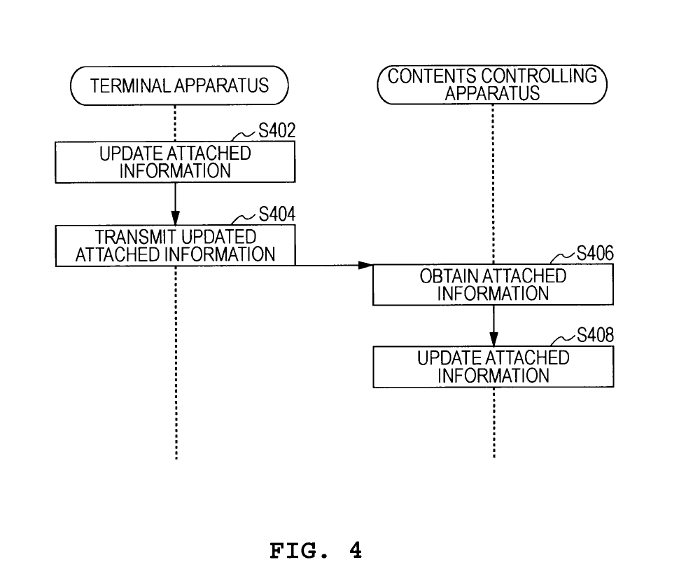

FIG. 4 shows another example of a processing procedure of the contents providing system 10. FIG. 4 shows an example of a processing procedure of the contents providing system 10 when a user of the terminal apparatus 100 updates the attached information.

First, the first attached information updating section 216 of the terminal apparatus 100 updates the attached information stored in the storage section 250 (step S402). Next, the attached information transmission section 218 of the terminal apparatus 100 transmits the attached information updated in step S402 to the contents controlling apparatus 110 (step S404). At this time, the attached information transmission section 218 does not transmit the content corresponding to the attached information to the contents controlling apparatus 110.

The attached information obtaining section 262 of the contents controlling apparatus 110 obtains the attached information transmitted in step S404 (step S406). Further, the second attached information updating section 264 of the contents controlling apparatus 110 updates the attached information stored in the storage section 250 by using the attached information obtained in step S406 (step S408).

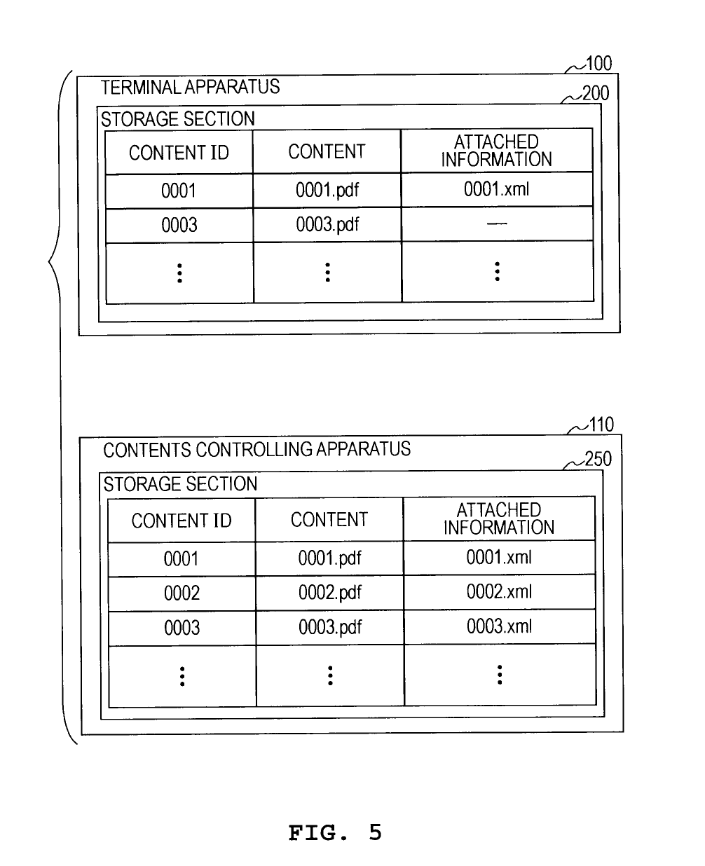

FIG. 5 shows an example of information stored in the contents providing system 10. In FIG. 5, a content and an attached information item of the content are associated with one of a plurality of content IDs and stored in the storage section 200 of the terminal apparatus 100 and the storage section 250 of the contents controlling apparatus 110.

For example, a content “0001.pdf” and attached information “0001.xml” of the content are associated with a content ID “0001” and stored in the storage section 250. Also, a content “0002.pdf” and attached information “0002.xml” of the content are associated with a content ID “0002” and stored in the storage section 250. Also, a content “0003.pdf” and attached information “0003.xml” of the content are associated with a content ID “0003” and stored in the storage section 250.

On the other hand, the content “0001.pdf” and the attached information “0001.xml” of the content are associated with the content ID “0001” and stored in the storage section 250. Also, the content “0003.pdf” is associated with the content ID “0003” and stored in the storage section 200.

As shown in FIG. 5, in the storage section 250, the content “0002.pdf” and the attached information “0002.xml” are stored. However, in the storage section 200, the content “0002.pdf” and the attached information “0002.xml” are not stored. In the storage section 250, the attached information “0003.xml” is stored. However, in the storage section 200, the attached information “0003.xml” is not stored.

For example, when the content “0002.pdf” is selected in the terminal apparatus 100, the terminal apparatus 100 requests the content “0002.pdf” and the attached information “0002.xml” from the contents controlling apparatus 110. Thereby, the content “0002.pdf” and the attached information “0002.xml” are transferred from the contents controlling apparatus 110 to the terminal apparatus 100. Then, the terminal apparatus 100 stores the content “0002.pdf” and attached information “0002.xml” obtained from the contents controlling apparatus 110 in the storage section 200.

When the content “0003.pdf” is selected in the terminal apparatus 100, the terminal apparatus 100 does not request the content “0003.pdf” from the contents controlling apparatus 110, but requests the attached information “0003.xml” from the contents controlling apparatus 110. Thereby, the attached information “0003.xml” is transferred from the contents controlling apparatus 110 to the terminal apparatus 100. However, the content “0003.pdf” is not transferred. Then, the terminal apparatus 100 associates the attached information “0003.xml” obtained from the contents controlling apparatus 110 with the content “0003.pdf” and stores the attached information “0003.xml” in the storage section 200.

When any of the attached information items is updated in the terminal apparatus 100, the terminal apparatus 100 does not request the content associated with the updated attached information from the contents controlling apparatus 110, but transmits the updated attached information to the contents controlling apparatus 110. Thereby, the contents controlling apparatus 110 updates an attached information item which is included in the attached information items stored in the storage section 250 and has the same content ID as that of the attached information updated in the terminal apparatus 100, by using the attached information updated in the terminal apparatus 100.

As described above, according to the contents providing system 10 of this embodiment, when the terminal apparatus 100 stores the content, although the attached information of the content is transferred from the contents controlling apparatus 110 to the terminal apparatus 100, the content is not transferred. Thereby, an amount of data transferred between the contents controlling apparatus 110 and the terminal apparatus 100 can be reduced. As a result, it is possible to perform data communication without applying a heavy load to the communication network 120.

According to the contents providing system 10 of this embodiment, when the terminal apparatus 100 updates an attached information, although the updated attached information is transferred from the terminal apparatus 100 to the contents controlling apparatus 110, the content associated with the updated attached information is not transferred. Thereby, also when the terminal apparatus 100 updates the attached information, an amount of data transferred between the contents controlling apparatus 110 and the terminal apparatus 100 can be reduced. As a result, it is possible to perform data communication without applying a heavy load to the communication network 120.

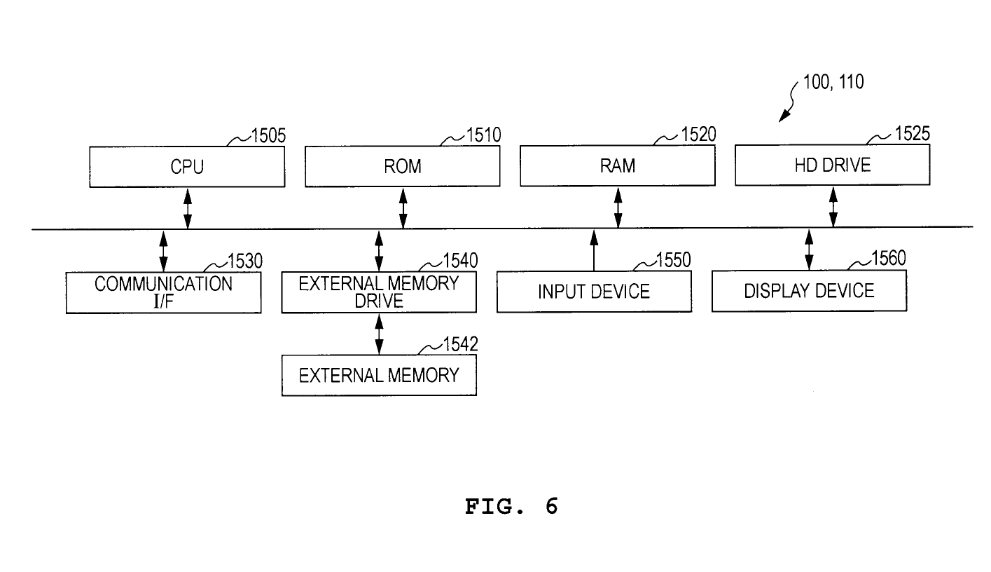

FIG. 6 shows an example of a hardware configuration of the terminal apparatus 100 and the contents controlling apparatus 110. The terminal apparatus 100 and the contents controlling apparatus 110 respectively include CPU 1505, ROM 1510, RAM 1520, an HD (hard disk) derive 1525, a communication interface 1530, an external memory drive 1540, an external memory 1542, an input device 1550, and a display device 1560.

The ROM 1510, the RAM 1520, and the HD drive 1525 store various data and various programs. At least one of the ROM 1510, the RAM 1520, and the HD derive 1525 included in the terminal apparatus 100 functions as the storage section 200 described related to FIGS. 1 to 5. Also, at least one of the ROM 1510, the RAM 1520, and the HD derive 1525 included in the contents controlling apparatus 110 functions as the storage section 250 described related to FIGS. 1 to 5.

The CPU 1505 performs various data processing and various hardware control operations by executing the program stored in the ROM 1510, the RAM 1520, or the HD derive 1525. The program executed by the CPU 1505 in the terminal apparatus 100 causes a computer to function as the obtaining section 202, the contents list obtaining section 206, the contents list updating section 208, the content selection section 210, the determination section 212, the first transfer control section 214, the first attached information updating section 216, and the attached information transmission section 218 which are described related to FIGS. 1 to 5. Also, the program executed by the CPU 1505 in the contents controlling apparatus 110 causes a computer to function as the transfer section 252, the contents list transmission section 256, the contents list updating section 258, the second transfer control section 260, the attached information obtaining section 262, and the second attached information updating section 264 which are described related to FIGS. 1 to 5.

The communication interface 1530 connects to the communication network, and transmits/receives data to/from an external apparatus via the communication network. The external memory drive 1540 connects to the external memory 1542, and transmits/receives data to/from an external memory 1542. The external memory 1542 is, for example, a memory card. The external memory 1542 may be a record medium such as a flexible disk, a CD, and a DVD. The external memory 1542 included in the terminal apparatus 100 may function as the storage section 200 described related to FIGS. 1 to 5. Also, the external memory 1542 included in the contents controlling apparatus 110 may function as the storage section 250 described with reference to FIGS. 1 to 5.

The display device 1560 displays various data. For example, the display device 1560 displays contents, attached information, a contents list, a control screen of these data, and the like. The display device 1560 is, for example, a CRT display, a liquid crystal display, a plasma display, an organic EL display, an electronic paper, or the like. The input device 1550 included in the terminal apparatus 100 is for inputting an operation to the terminal apparatus 100. The input device 1550 included in the contents controlling apparatus 110 is for inputting an operation to the contents controlling apparatus 110. For example, the input device 1550 is for inputting a content selection operation, an attached information editing operation, a contents controlling operation, and the like. The input device 1550 is, for example, a mouse, a keyboard, an input button, a touch panel, or the like.

For example, the program executed by the CPU 1505 may be recorded in a computer readable record medium, provided to the terminal apparatus 100 and the contents controlling apparatus 110 by the computer readable record medium, and installed in the terminal apparatus 100 and the contents controlling apparatus 110. Not limited to this, the program executed by the CPU 1505 may be provided to the terminal apparatus 100 and the contents controlling apparatus 110 from an external apparatus via a communication network, and installed in the terminal apparatus 100 and the contents controlling apparatus 110.

### Embodiment 2

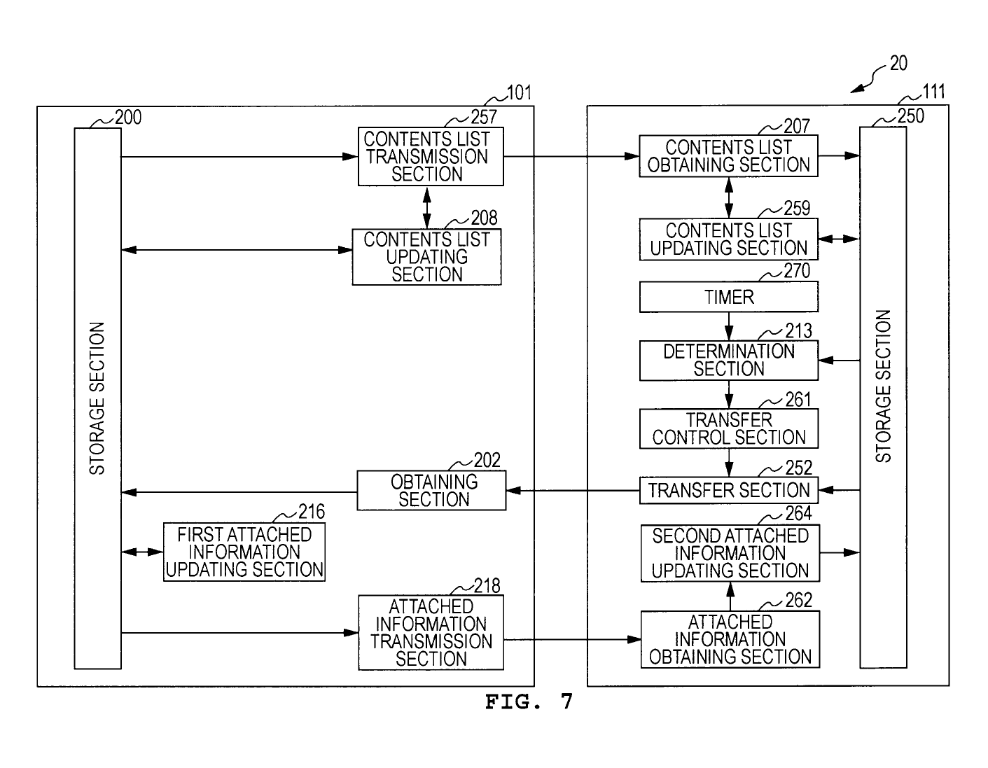

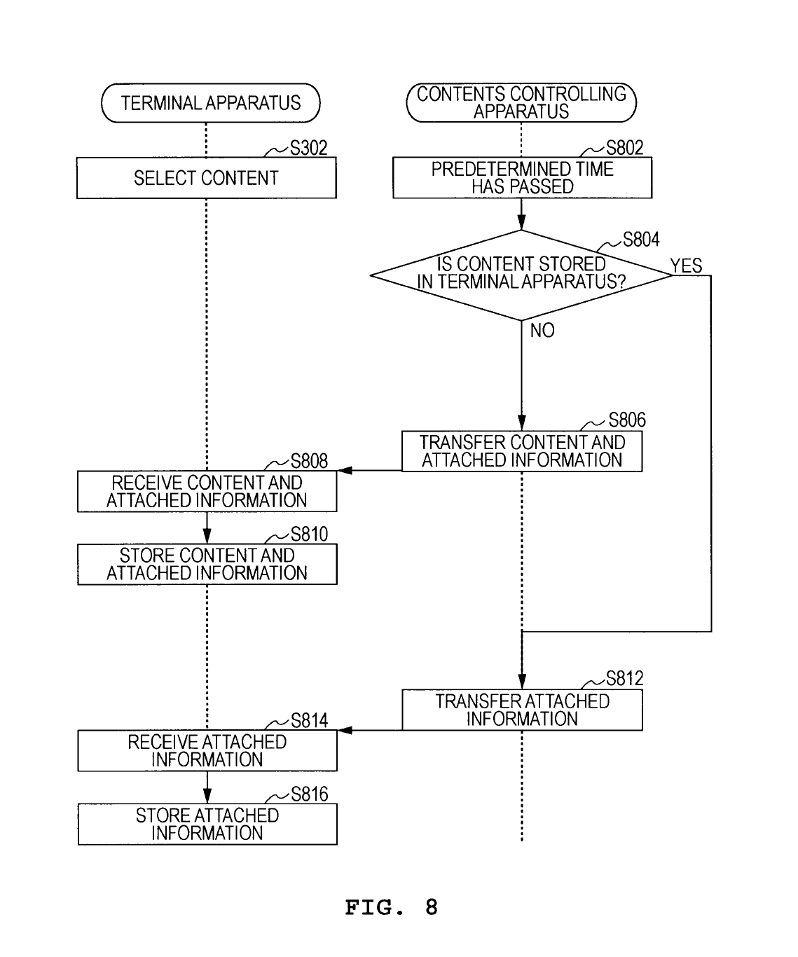

Although, in the embodiment 1, an example is shown in which the determination section 212 included in the terminal apparatus 100 determines whether or not the content selected in step 302 is stored in the terminal apparatus 100, in an embodiment 2, an example is shown in which the contents controlling apparatus determines whether or not a predetermined content is stored in the terminal apparatus. Hereinafter, points different from the embodiment 1 will be mainly described with reference to FIGS. 7 and 8.

FIG. 7 shows an example of a functional configuration of a contents providing system 20 according to the embodiment 2. The contents providing system 20 includes a terminal apparatus 101 and a contents controlling apparatus 111. The terminal apparatus 101 includes the storage section 200, the obtaining section 202, the contents list updating section 208, the first attached information updating section 216, the attached information transmission section 218, and a contents list transmission section 257. The contents controlling apparatus 111 includes the storage section 250, the transfer section 252, the attached information obtaining section 262, the second attached information updating section 264, a transfer control section 261, a contents list obtaining section 207, a determination section 213, a contents list updating section 259, and a timer 270.

First, the terminal apparatus 101 will be described. The storage section 200, the contents list updating section 208, the obtaining section 202, the first attached information updating section 216, and the attached information transmission section 218 respectively have the same functions as those of the storage section 200, the contents list updating section 208, the obtaining section 202, the first attached information updating section 216, and the attached information transmission section 218 included in the terminal apparatus 100 of the embodiment 1. The contents list transmission section 257 transmits the contents list created by the contents list updating section 208 to the contents controlling apparatus 111. For example, the contents list transmission section 257 extracts the contents list of the terminal apparatus 101 from the storage section 200, and transmits the extracted contents list of the terminal apparatus 101 to the contents controlling apparatus 111.

Next, the contents controlling apparatus 111 will be described. The storage section 250, the attached information obtaining section 262, the second attached information updating section 264, and the transfer section 252 respectively have the same functions as those of the storage section 250, the attached information obtaining section 262, the second attached information updating section 264, and the transfer section 252 included in the contents controlling apparatus 110 of the embodiment 1.

The contents list obtaining section 207 obtains the contents list. For example, the contents list obtaining section 207 obtains the contents list of the terminal apparatus 101 transmitted from the terminal apparatus 101. The contents list obtaining section 207 stores the obtained contents list of the terminal apparatus 101 in the storage section 250.

The contents list updating section 259 refers to the storage section 250, and creates the contents list of the contents controlling apparatus 111. The contents list updating section 259 stores the created contents list of the contents controlling apparatus 111 in the storage section 250. The contents list updating section 259 refers to the storage section 250 at regular intervals or at an arbitrary timing, and updates the contents list of the contents controlling apparatus 111 stored in the storage section 250 to the latest state. Also, the contents list updating section 259 causes the contents list obtaining section 207 to obtain the latest contents list of the terminal apparatus 101 at regular intervals or at an arbitrary timing, and updates the contents list of the terminal apparatus 101 stored in the storage section 250 to the latest state.

The determination section 213 sets a parameter value in advance for at least one of parameters such as a file name, a file type, a storage directory, a creation date, and so on. For example, a PDF file is set as a parameter value representing a file type, and directory A and directory B are set as parameters representing a storage directory. These parameter values may be values set in advance by an administrator of the contents providing system 20, or may be values set by a user of the terminal apparatus 101.

The contents controlling apparatus 111 includes the timer 270. By an instruction from the timer 270, the determination section 213 determines whether or not a content having a parameter value corresponding to the parameter value set in advance is stored in the terminal apparatus 101. In this example, the determination section 213 performs the following determination for each PDF file (content) stored in the directory A or the directory B: Specifically, depending on whether or not a content having a parameter value corresponding to the parameter value set in advance is shown in the contents list of the terminal apparatus 101, the determination section 213 determines whether or not the content is stored in the terminal apparatus 101. In addition, the determination section 213 may determine whether or not the content is stored in the terminal apparatus 101 by obtaining a file list of the storage section 200 and a file list of the storage section 250 and referring to the obtained file lists without referring to the contents list.

The transfer control section 261 controls transfer of a content from the contents controlling apparatus 111 to the terminal apparatus 101. Specifically, when the determination section 213 determines that a content having a parameter value corresponding to the parameter value set in advance is not stored in the terminal apparatus 101, the transfer control section 261 issues an instruction for transmitting the content to the terminal apparatus 101 to the transfer section 252. The transfer section 252 receives the instruction from the transfer control section 261, and transmits the content to the terminal apparatus 101. When the attached information of the content is stored in the storage section 250 included in the contents controlling apparatus 111, the transfer control section 261 issues an instruction for transmitting the attached information of the content to the terminal apparatus 101 to the transfer section 252. The transfer section 252 receives the instruction from the transfer control section 261, and transmits the attached information stored in the storage section 250 included in the contents controlling apparatus 111 to the terminal apparatus 101.

On the other hand, when the determination section 213 determines that a content having a parameter value corresponding to the parameter value set in advance is stored in the terminal apparatus 101, the transfer control section 261 issues an instruction for transmitting the attached information of the content to the terminal apparatus 101 to the transfer section 252. The transfer section 252 receives the instruction from the transfer control section 261, and transmits the attached information stored in the storage section 250 included in the contents controlling apparatus 111 to the terminal apparatus 101. In this case the content is not transferred from the contents controlling apparatus 111 to the terminal apparatus 101.

FIG. 8 shows an example of a processing procedure of the contents providing system 20. Here, it is assumed that a parameter value is set in advance for at least one of parameters such as a file name, a file type, a storage directory, a creation date, and so on.

First, in the contents controlling apparatus 111, the timer 270 informs the determination section 213 that a predetermined time has passed (step S802), and responding to this, the determination section 213 determines whether or not a content having a parameter value corresponding to the parameter value set in advance is stored in the terminal apparatus 101 (step S804). In step S804, when the determination section 213 determines that a content having a parameter value corresponding to the parameter value set in advance is not stored in the terminal apparatus 101 (step S804: No), the transfer section 252 receives an instruction from the transfer control section 261, and transfers the content to the terminal apparatus 101 (step S806). At this time, when the transfer section 252 receives an instruction for transmitting the attached information of the content to the terminal apparatus 101, the transfer control section 252 also transmits the attached information to the terminal apparatus 101. The content and the attached information of the content transferred from the contents controlling apparatus 111 are received by the obtaining section 202 in the terminal apparatus 101 (step S808), and stored in the storage section 200 (step S810).

On the other hand, in step S804, when the determination section 212 determines that a content having a parameter value corresponding to the parameter value set in advance is stored in the terminal apparatus 101 (step S804: Yes), the transfer section 252 receives an instruction from the transfer control section 261, and transfers the attached information of the content to the terminal apparatus 101 (step S812). At this time, the transfer section 252 does not transfer the content to the terminal apparatus 101. The attached information of the content transferred from the contents controlling apparatus 111 is received by the obtaining section 202 in the terminal apparatus 101 (step S814), and stored in the storage section 200 (step S816).

The terminal apparatus 101 according to this embodiment includes the first attached information updating section 216 and the attached information transmission section 218, and the first attached information updating section 216 can update attached information stored in the storage section 200. An update method for updating the attached information in the contents controlling apparatus 111 when the attached information is updated in the terminal apparatus 101 is the same as that in the first embodiment, so that the description is omitted.

According to the contents providing system 20 of this embodiment, the same effect as that of the embodiment 1 can be obtained. In addition, in the contents providing system 20, the determination section is not included in the terminal apparatus 101, but included in the contents controlling apparatus 111, so that it is possible to reduce the load of the terminal apparatus 101. Although, in this embodiment, the terminal apparatus 101 and the contents controlling apparatus 111 are synchronized based on an instruction from the timer 270 included in the contents controlling apparatus 111, it is possible to synchronize the terminal apparatus 101 and the contents controlling apparatus 111 with respect to a content selected by a user by providing a content selection section in the terminal apparatus 101 in the same way as in the embodiment 1.

What is claimed is:

1. A contents providing system which provides a content and attached information of the content stored in a contents controlling apparatus to a terminal apparatus, the contents providing system comprising:
a determination section that determines whether or not a specific content among a plurality of contents stored in the contents controlling apparatus is stored in the terminal apparatus; and
a transfer section that transfers the specific content and attached information of the specific content to the terminal apparatus when the determination section determines that the specific content is not stored in the terminal apparatus, and transfers only the attached information of the specific content instead of both the specific content and the attached information of the specific content when the determination section determines that the specific content is stored in the terminal apparatus.

2. The contents providing system according to claim 1, further comprising:
a first attached information updating section that creates updated attached information by updating the attached information stored in the terminal apparatus;
an attached information transmission section that transmits the updated attached information to the contents controlling apparatus; and
a second attached information updating section that updates the attached information stored in the contents controlling apparatus by using the updated attached information.

3. A terminal apparatus which stores a specific content among a plurality of contents stored in a contents controlling apparatus and attached information of the specific content, the terminal apparatus comprising:
a determination section that determines whether or not the specific content is stored in the terminal apparatus; and
a transfer section that controls the contents controlling apparatus so that the contents controlling apparatus transfers the specific content and the attached information of the specific content to the terminal apparatus when the determination section determines that the specific content is not stored in the terminal apparatus, and controls the contents controlling apparatus so that the contents controlling apparatus transfers only the attached information of the specific content instead of both the specific content and the attached information of the specific content when the determination section determines that the specific content is stored in the terminal apparatus.

4. The terminal apparatus according to claim 3, further comprising:
a first attached information updating section that creates updated attached information by updating the attached information transferred from the contents controlling apparatus; and
an attached information transmission section that transmits the updated attached information to the contents controlling apparatus.

5. A contents controlling apparatus which provides a specific content among a plurality of contents and attached information of the specific content to a terminal apparatus, the contents controlling apparatus comprising:
a determination section that determines whether or not the specific content is stored in the terminal apparatus; and
a transfer section that transfers the specific content and attached information of the specific content to the terminal apparatus when the determination section determines that the specific content is not stored in the terminal apparatus, and transfers only the attached information of the specific content instead of both the specific content and the attached information of the specific content when the determination section determines that the specific content is stored in the terminal apparatus.

6. The contents controlling apparatus according to claim 5, further comprising:
an attached information updating section that updates the attached information stored in the contents controlling apparatus by using attached information transferred from the terminal apparatus.
